(19) United States
(12) Patent Application Publication
(10) Pub. No.: US 2026/0034673 A1
(43) Pub. Date: Feb. 5, 2026

(54) ROBOT CALIBRATION METHOD AND APPARATUS, ELECTRONIC DEVICE AND STORAGE MEDIUM

(71) Applicant: JAKA ROBOTICS CO., LTD., Shanghai (CN)

(72) Inventors: Chunxiao ZHU, Shanghai (CN); Fan YANG, Shanghai (CN); Xiaoshan WANG, Shanghai (CN); Zhenxiang QI, Shanghai (CN); Xiong XU

(21) Appl. No.: 18/997,011

(22) PCT Filed: Jun. 29, 2023
(86) PCT No.: PCT/CN2023/103546

§ 371 Date: Jan. 18, 2025

(30) Foreign Application Priority Data
Jul. 20, 2022 (CN) 202210872448.7

(51) Int. Cl. B25J 9/16

(52) U.S. Cl. CPC B25J 9/1692; B25J 9/1605

(57) ABSTRACT

Provided are a robot calibration method and apparatus, an electronic device and a storage medium. The method comprises: establishing an i-th kinematic model between a first coordinate system of an i-th calibration block and a second coordinate system of a detection end of a robot, wherein i is a positive integer greater than or equal to 1 and less than or equal to n, and n is the number of calibration blocks; determining a plurality of pieces of pose data of the detection end in contact with a plurality of test points on the i-th calibration block; determining a plurality of contact coordinates of the detection end according to the plurality of pieces of pose data and the i-th kinematic model; and determining a measurement parameter of the robot according to n groups of contact coordinates corresponding to the n calibration blocks.

### CROSS-REFERENCE TO RELATED APPLICATION

The present disclosure claims priority to Chinese patent Application No. 202210872448.7, filed with the Chinese Patent Office on Jul. 20, 2022, entitled “ROBOT CALIBRATION METHOD AND APPARATUS, ELECTRONIC DEVICE AND STORAGE MEDIUM” the entire contents of which are incorporated herein by reference.

### TECHNICAL FIELD

The present disclosure relates to the technical field of robotic automation, and specifically to a robot calibration method, an apparatus, an electronic device, and a storage medium.

### BACKGROUND ART

Accuracy is one of the important performance parameters of a robot. Due to factors such as machining tolerances, assembly errors, and elastic deformation of the rod joint, there are errors between the actual geometric parameters and the theoretical parameters of the robot. These geometric parameters are used to calculate the forward and inverse kinematics of the robot, but the parametric error of the geometric parameters will affect the operation accuracy of the robot.

In the related art, the geometric parameter can be corrected, wherein the error of the kinematic parameter can be compensated by parametric calibration, so as to improve the absolute accuracy of the robot. However, current calibration techniques usually measure poses of the end executor of the robot relying on an external measurement device, which results in lower accuracy of the kinematic parameter calibration of the robot.

### SUMMARY

In view of this background, the embodiments of the present disclosure provide a robot calibration method, an apparatus, an electronic device, and a storage medium to solve the problem of low accuracy when calibrating a robot in the related art.

In order to solve the above problems, some embodiments of the present disclosure provide a robot calibration method, and the robot calibration method can include:
establishing an i-th kinematic model between a first coordinate system of an i-th calibration block and a second coordinate system of a probe end of the robot, wherein i is a positive integer greater than or equal to 1 and smaller than or equal to n, and n is the quantity of calibration blocks;
determining a plurality of pose data of a plurality of test points on the i-th calibration block in contact with the probe end;
determining a plurality of contact coordinates of the probe end according to the plurality of pose data and the i-th kinematic model; and
determining a measurement parameter of the robot according to n groups of the contact coordinates corresponding to n calibration blocks.

In the above realization process, by establishing the kinematic model between the coordinate systems of the calibration block and the probe end, it can combine the pose data when the probe end is in contact with the calibration block, so as to obtain the plurality of contact coordinates in the first coordinate system when the probe end is in contact, so as to determine real kinematics measurement parameters of the robot during the movement process according to the plurality of contact coordinates of the plurality of calibration blocks. The entire workspace of the robot can be measured when calibrating, which can realize the automatic closed-loop calibration of the robot; and it does not need an external measurement apparatus for open-loop calibration, which reduces the cost and time consumption for the robot calibration, thus effectively improving the accuracy and efficiency of the robot calibration.

In some optional embodiments of the present disclosure, the step of determining a plurality of pose data of a plurality of test points on the i-th calibration block in contact with the probe end can include:
testing a contact strength of the probe end in contact with each test point according to a sensor on the probe end; and
acquiring a current pose data of the robot when the contact strength satisfies a strength threshold, wherein the pose data includes joint angle data of a plurality of joints of the robot.

In the above realization process, in order for the probe end to accurately touch the surface of the calibration block, the sensor can be arranged on the probe end, so as to test the contact strength of the probe end when it contacts the test point on the surface of the calibration block. When the contact strength meets a preset strength threshold, it determines that the probe end normally touches the calibration block, so that the current pose data of the robot can be acquired, and the plurality of pose data can be obtained by repeating the contact and determining process. It can normally contact with a constant force, which avoids adverse effects on the pose data due to insufficient or excessive force, thereby effectively improving the accuracy of the pose data.

In some optional embodiments of the present disclosure, the step of determining a plurality of contact coordinates of the probe end according to the plurality of pose data and the i-th kinematic model can include:
determining a setting parameter of the robot; and
substituting each pose data and the setting parameter into the i-th kinematic model, so as to determine the plurality of contact coordinates in the first coordinate system when the probe end contacts the plurality of test points.

In the above realization process, the set kinematic parameter of the robot is determined according to its model, type, etc. Each pose data and the setting parameter are submitted into the corresponding kinematic model for calculation, so as to determine the contact coordinate of the probe head in contact with the calibration block when the robot is in the plurality of different poses, thereby realizing the conversion of the pose of the robot to the position in the first coordinate system, and effectively improving the correlation between the contact coordinates and the pose data.

In some optional embodiments of the present disclosure, the robot calibration method can further include:
establishing a corresponding plane equation according to each measured plane of the i-th calibration block, wherein the i-th calibration block includes a plurality of measured planes, and each measured plane includes a plurality of test points.

In the above realization process, since each calibration block has a plurality of measured plane, the probe end of the robot can contact each measured plane during the test, so that each measured plane includes a plurality of test points when the probe end makes contact. The corresponding plane equations can be established according to each measured plane in the calibration block, so as to determine whether the contact coordinates corresponding to the pose data of each test point meet the accuracy during calibration.

In some optional embodiments of the present disclosure, the step of determining a measurement parameter of the robot according to n groups of the contact coordinates corresponding to n calibration blocks can include:
determining a plurality of groups of fitting coordinates according to n groups of the contact coordinates and n kinematic models;
substituting each group of the fitting coordinates into the corresponding plane equation to establish system of error equations;
fitting based on the system of error equations to determine the error parameter; and
determining the measurement parameter of the robot according to the error parameter and the setting parameter of the robot.

In the above realization process, the plurality of groups of contact coordinates can be substituted into the Jacobi matrix of the corresponding kinematic model respectively, so as to determine the corresponding plurality of groups of fitting coordinates corresponding to the kinematic parameter set by the robot, and to fit the system of error equations established according to the fitting coordinates and the corresponding plane equation, so that the error parameter obtained by the robot kinematic calibration can be determined. Therefore, the actual kinematic measurement parameter is obtained after the measurement of the robot according to the setting parameter and the error parameter is determined, so as to calibrate and correct the kinematic parameter, which effectively improves the accuracy of the obtained measurement parameter.

In some optional embodiments of the present disclosure, the robot calibration method can further include:
determining n groups of measurement coordinates of the probe end contacting n calibration blocks according to the measurement parameter;
determining whether the plurality of measurement coordinates on each measured plane satisfy the corresponding plane equation; and
determining an adjustment measurement parameter of the robot when the measurement coordinate does not satisfy the corresponding plane equation until a plurality of current adjustment measurement coordinates satisfy the corresponding plane equation.

In the above realization process, after the kinematic parameter of the robot is corrected, it can further re-teach according to the measurement parameters obtained by correction, wherein the probe end can continue to contact the plurality of calibration blocks by using the modeling, pose determination, conversion, and other methods previously used, so as to obtain a plurality of groups of measurement coordinates corresponding to the plurality of calibration blocks. It is to determine whether the plurality of measurement coordinates belonging to the same measured plane satisfy the plane equation corresponding to the measured plane, wherein it is to continue to calibrate the measurement parameters when it is not satisfied, so as to obtain the adjustment measurement parameter, and it continues to teach to obtain the corresponding adjustment measurement coordinate according to the adjustment measurement parameters. The process of calibrating and determining is repeated until the plurality of current adjustment measurement coordinates on the same measured plane satisfy the corresponding plane equation. The kinematic parameter of the robot can be verified after the calibration and correction, and the accuracy of calibration is improved by repeated calibration, so as to further improve the accuracy for the control of the robot.

In some optional embodiments of the present disclosure, the robot calibration method can further include:
determining the n calibration blocks in a plurality of directions according to an arm length of the robot;
establishing the first coordinate system according to a center of the i-th calibration block among the n calibration blocks during the calibration;
establishing a second coordinate system according to the probe end of the robot; and
establishing a third coordinate system according to a base of the robot.

In the above realization process, in order to realize the high-accuracy calibration for testing the entire workspace of the robot, the plurality of corresponding calibration blocks can be determined according to the arm length of the robot, so as to establish corresponding coordinate systems according to the calibration block, the probe end of the robot, and the base during the calibration respectively.

In some optional embodiments of the present disclosure, the n calibration blocks can be uniformly sized calibration blocks, and each calibration block has one or more levels of plane perpendicularity.

In some optional embodiments of the present disclosure, the step of establishing an i-th kinematic model between a first coordinate system of an i-th calibration block and a second coordinate system of a probe end of the robot can include:
establishing a first transformation relationship between the first coordinate system and the third coordinate system;
establishing a second transformation relationship between the second coordinate system and the third coordinate system; and
establishing the i-th kinematic model between the first coordinate system and the second coordinate system based on the first transformation relationship and the second transformation relationship.

In the above realization process, since the third coordinate system of the base and the first coordinate system of the calibration block are relatively stationary, it can first establish the first transformation relationship between the first coordinate system and the third coordinate system and the second transformation relationship between the second coordinate system and the third coordinate system, and then establish the kinematic model between the first coordinate system and the second coordinate system in the i-th calibration block based on the kinematic modeling method according to the first transformation relationship and the second transformation relationship. It can determine the kinematic model between each calibration block and the probe end according to the relationship between three coordinate systems of different calibration blocks and robots, so as to realize the transformation between the pose and the position.

Some embodiments of the present disclosure further provide a robot calibration apparatus, wherein the robot calibration apparatus can include:
a modeling module, wherein the modeling module is configured to establish an i-th kinematic model between a first coordinate system of an i-th calibration block and a second coordinate system of a probe end of the robot, wherein i is a positive integer larger than or equal to 1 and smaller than or equal to n, and n is an amount of calibration blocks;
a recording module, wherein the recording module is configured to determine a plurality of pose data of a plurality of test points on the i-th calibration block in contact with the probe end;
a determination module, wherein the determination module is configured to determine a plurality of contact coordinates of the probe end according to the plurality of the pose data and the i-th kinematic model; and
a calibration module, wherein the calibration module is configured to determine a measurement parameter of the robot according to n groups of the contact coordinates corresponding to n calibration blocks.

Some embodiments of the present disclosure further provide an electronic device, and the electronic device can include a memory and a processor, wherein the memory stores program instructions, and the processor performs the steps in any one of the embodiments in the foregoing robot calibration method when reading and running the program instructions.

Some embodiments of the present disclosure further provide a computer-readable storage medium, and the computer-readable storage medium stores computer program instructions, wherein the computer program instructions perform the steps in any one of the embodiments in the foregoing robot calibration method when read and run by one processor.

In summary, the present disclosure provides a robot calibration method, apparatus, electronic device, and storage medium. The transformation between the pose and the position can be realized by the kinematic model, wherein the entire workspace of the robot can be measured when calibrating, and the actual kinematic parameter of the robot can be determined, which can realize the automatic closed-loop calibration of the robot; and it does not need an external measurement apparatus for open-loop calibration, which reduces the cost and time consumption for the robot calibration, thus effectively improving the accuracy and efficiency of the robot calibration.

### BRIEF DESCRIPTION OF DRAWINGS

In order to more clearly illustrate the technical solutions in the embodiments of the present disclosure, the drawings to be used in the embodiments of the present disclosure will be briefly introduced below. It is to be understood that the following drawings only show certain embodiments of the present disclosure, and therefore should not be regarded as a limitation of the scope. For persons of ordinary skill in the field, other relevant drawings can be obtained according to these drawings without inventive efforts.

FIG. 1 is a block schematic diagram of an electronic device provided by an embodiment of the present disclosure;

FIG. 2 shows a flow schematic diagram of a robot calibration method provided by an embodiment of the present disclosure;

FIG. 3 shows a detailed flow schematic diagram of step S300 provided by an embodiment of the present disclosure;

FIG. 4 shows a detailed flow schematic diagram of step S400 provided by an embodiment of the present disclosure;

FIG. 5 shows a detailed flow schematic diagram of step S500 provided by an embodiment of the present disclosure;

FIG. 6 shows a flow schematic diagram of another robot calibration method provided by an embodiment of the present disclosure;

FIG. 7 shows a flow schematic diagram of another robot calibration method provided by an embodiment of the present disclosure;

FIG. 8 shows a detailed flow schematic diagram of step S200 provided by an embodiment of the present disclosure;

FIG. 9 shows a schematic diagram of a module structure of a robot calibration apparatus provided by an embodiment of the present disclosure; and

FIG. 10 shows an operation schematic diagram of a robot calibration method provided by an embodiment of the present disclosure.

Reference numbers: 100—electronic device; 111—memory; 112—memory controller; 113—processor; 114—peripheral interface; 115—communication unit; 116—display unit; 800—robot calibration apparatus; 810—modeling module; 820—recording module; 830—determination module; 840—calibration module; 900—robot; 910—probe end; 911—sensor; 920—calibration table; 921—distance adjustment rail; 931—first calibration block; 932—second calibration block; 933—third calibration block.

### DETAILED DESCRIPTION OF EMBODIMENTS

The technical solutions in the embodiments of the present disclosure will be clearly and completely described in conjunction with the drawings in the embodiments of the present disclosure. It is clear that the embodiments described are partial embodiments of embodiments of the present disclosure, but not all of the embodiments. Based on the embodiments of the present disclosure, all other embodiments obtained by a person of ordinary skill in the art without inventive efforts, shall fall within the scope of protection of the embodiments of the present disclosure.

In the current kinematic calibration methods for the robot, it usually measures poses of the end executor of the robot relying on an external measurement device, which belongs to the open-loop calibration method. However, due to the accuracy requirement in calibration, it is needs to use the expensive or complex measuring apparatus for measurement, such as the theodolite, laser tracker, and other instruments, wherein the accuracy of these instruments will affected by temperature, humidity, and other factors in the environment when calibrating. Additionally, when using an external apparatus for measurement, it cannot measure all poses of the end executor of the robot due to the positional limitations of the external apparatus. Therefore, when calibrating the robot by using the external apparatus, the cost is higher, the time consumption is longer, and the calibration accuracy is easily affected and incomplete, which results in the lower accuracy of the current robot kinematic parameter calibration.

In order to solve the above problems, the embodiments of the present disclosure provide a robot calibration method applied to the electronic device, wherein the electronic device can be a server, a personal computer (PC), a tablet computer, a smartphone, a personal digital assistant (PDA), and other electronic device with logic computing functions, which can convert poses of the robot to positional information in the calibration block, so as to measure the real kinematic parameter of the robot during its movement.

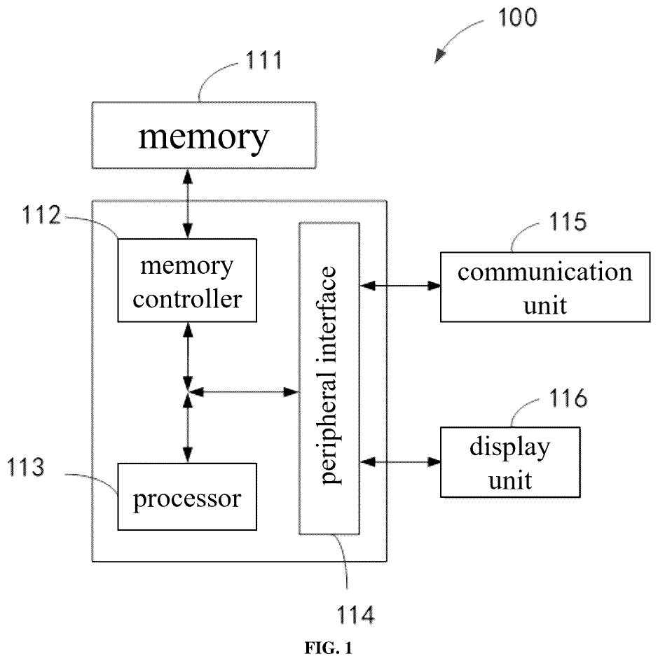

Optionally, referring to FIG. 1, FIG. 1 is a block schematic diagram of an electronic device provided by an embodiment of the present disclosure. The electronic device 100 can be arranged inside the robot or can be a separate device, which is used to control the movement of the robot and acquire a variety of data during the movement. The electronic device 100 can include a memory 111, a memory controller 112, a processor 113, a peripheral interface 114, a communication unit 115, and a display unit 116. A person of ordinary skill in the art can understand that the structure shown in FIG. 1 is only illustrative, and it does not limit the structure of the electronic device 100. For example, the electronic device 100 can further include more or fewer components than shown in FIG. 1, or have a different configuration than shown in FIG. 1.

The components of the above memory 111, the memory controller 112, the processor 113, the peripheral interface 114, the communication unit 115, and the display unit 116 are electrically connected to each other directly or indirectly, so as to realize the transmission or interaction of data. For example, these components can be electrically connected to each other via one or more communication buses or signal lines. The processor 113 above is used to execute executable modules stored in the memory.

The memory 111 can be, but is not limited to, a random access memory (RAM), a read only memory (ROM), a programmable read-only memory (PROM), an erasable programmable read-only memory (EPROM), and an electrically erasable programmable read-only memory (EEPROM), etc. The memory 111 is used to store the program; the processor 113 executes the program after receiving the execution instruction; and the method performed by the electronic device 100 as defined by the process disclosed in any one of the embodiments of the present disclosure can be applied to the processor 113 or realized by the processor 113.

The foregoing processor 113 can be an integrated circuit chip with the signal processing capability. The foregoing processor 113 can be a general purpose processor, including a central processing unit (CPU), a network processor (NP), or it can also be a digital signal processor (DSP), an application specific integrated circuit (ASIC), a field programmable gate array (FPGA), or other programmable logic components, such as discrete gates, transistor logic components, or discrete hardware components, which can be used to realize or execute the methods, steps, and logic block diagrams disclosed in embodiments of the present disclosure, wherein the general purpose processor can be a microprocessor, or the processor can be any conventional processor, etc.

Various input/output devices are coupled to the processor 113 and to the memory 111 by the above peripheral interface 114. In some embodiments, the peripheral interface 114, the processor 113, and the memory controller 112 can be realized in a single chip. In some other examples, they can be realized by separate chips respectively.

The above communication unit 115 is used to communicatively connect to the robot, so as to control the movement of the robot and to transmit data with the robot. The communication connection can be realized by a wired or wireless network connection or a Bluetooth connection. The communication unit 115 can be, but is not limited to, various communication chips, etc.

The above display unit 116 provides an interactive interface (such as a user operation interface) between the electronic device 100 and the user, or shows image data for the user reference. In the embodiment, the display unit can be a liquid crystal display or a touch display. If it is a touch display, it can be a capacitive touch screen or a resistive touch screen that supports single-point and multi-point touch operations. Supporting single-point and multi-touch operation means that the touch display can sense touch operations simultaneously generated from the last or more positions of the touch display and send the sensed touch operations to the processor for calculation and processing. In embodiments of the present disclosure, the display unit 116 can display a plurality of pose data, contact coordinates, and other data of the robot.

The electronic device in the embodiment can be used to execute various steps in the various robot calibration methods provided by embodiments of the present disclosure. The realization process of the robot calibration method is described in detail below by several embodiments.

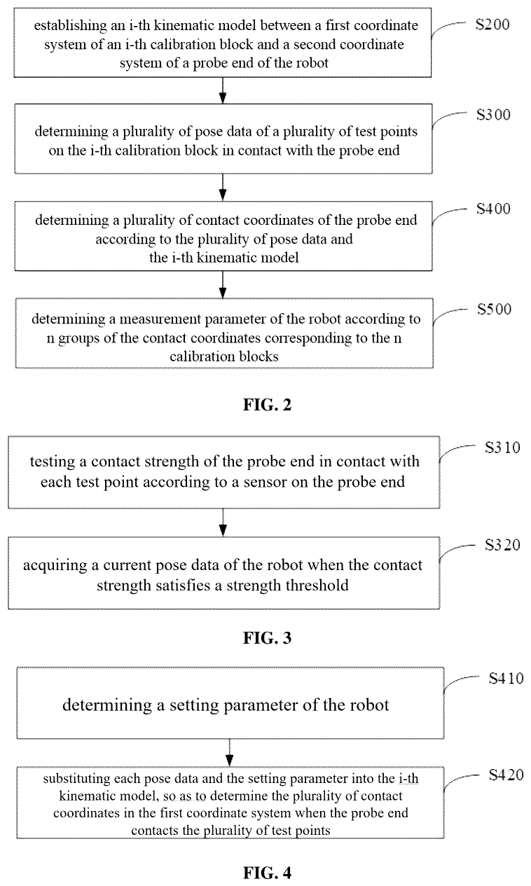

Referring to FIG. 2, FIG. 2 shows a flow schematic diagram of a robot calibration method provided by the embodiment of the present disclosure, and the method can include steps S200-S500.

Step S200: establishing an i-th kinematic model between a first coordinate system of an i-th calibration block and a second coordinate system of a probe end of the robot.

The i is a positive integer greater than or equal to 1 and less than or equal to n; and n is the amount of calibration blocks, wherein n can be the amount of calibration blocks set according to the actual situation of the robot, and the i-th calibration block is any one of the n calibration blocks. The probe end of the robot can be a test head on an end executor of the robot, which can be in contact with surfaces of a plurality of calibration blocks. When performing the calibration, the first coordinate system corresponding to the i-th calibration block is a fixed coordinate system, and the second coordinate system corresponding to the probe end is a coordinate system that changes according to the pose change of the robot. Therefore, it can transform the pose change of the robot to the position change of the i-th calibration block by establishing the i-th kinematic model between two coordinate systems.

Optionally, in order to facilitate the calibration of the robot, the plurality of calibration blocks can be fixed to the surface of the calibration table by a distance adjustment rail, and the positions of the plurality of calibration blocks can be adjusted according to the distance adjustment rail, so as to test and calibrate the entire workspace of the robot, which effectively improves the accuracy of the calibration.

Optionally, the i-th kinematic model can be a forward kinematic model, an inverse kinematic model, or a D-H model, etc.

Step S300: determine a plurality of pose data of a plurality of test points on the i-th calibration block in contact with the probe end.

Corresponding control commands can be sent to the robot, so as to plan a motion path of the robot and to change the pose of the robot, so that the probe end can contact a plurality of test points on the i-th calibration block, thereby obtaining the pose data of the robot when the probe end is in contact with a plurality of different test points.

In some optional embodiments of the present disclosure, the i-th calibration block can further include a plurality of measured planes, and each measured plane includes a plurality of test points. Exemplarily, the amount of measured planes is related to the shape of the calibration block. When the i-th calibration block is a cube, there are five measured planes when the i-th calibration block is arranged on the surface of the calibration table, which are distributed as a top plane Z, a left plane W, a right plane Y, a front plane U, and a back plane V. The test points can be randomly distributed on the corresponding five measured planes. In order to facilitate uniform computation and processing of each measured plane, the same amount of test points can be set in each measured plane, e.g., each of the five measured planes has ten test points.

It is worth stating that in order to constrain the position transitions during calibration, the method can further include: establishing a corresponding plane equation according to each measured plane of the i-th calibration block. Based on the first coordinate system of the i-th calibration block, the corresponding plane equation can be established according to each measured plane in the i-th calibration block for the subsequent constraint and detection.

Exemplarily, the first coordinate system of the i-th calibration block can be noted as O_XYZi, and then the plane equation of the Z-plane can be A_iZx+B_iZy+C_iZz=1; the plane equation of the W-plane can be A_iWx+B_iWy+C_iWz=1; the plane equation of the Y-plane can be A_iYx+B_iYy+C_iYz=1; the plane equation of the U-plane can be A_iUx+B_iUy+C_iUz=1; and the plane equation of the V-plane can be A_iVx+B_iVy+C_iVz=1.

Step S400: determining a plurality of contact coordinates of the probe end according to the plurality of pose data and the i-th kinematic model.

Through the i-th kinematic model, it can transform each determined pose data to one corresponding contact coordinate in the first coordinate system of the i-th calibration block, so as to obtain a plurality of contact coordinates corresponding to the pose when the probe end is in contact with the plurality of test points on the plurality of measured planes of the i-th calibration block, so as to realize a targeted conversion from the pose change of the robot to the position in the calibration block, which effectively improves the accuracy of the contact coordinates.

Step S500: determining a measurement parameter of the robot according to n groups of contact coordinates corresponding to n calibration blocks.

The plurality of contact coordinates obtained after the probe end is in contact with each calibration block and the pose data is determined and transformed, and can be assembled as a group of contact coordinates when testing the calibration block. When n groups of calibration blocks are all tested, n groups of contact coordinates respectively corresponding to n calibration blocks can be obtained. The actual kinematic parameter of the robot can be obtained by fitting and calculating according to n groups of contact coordinates, and it is taken as a measurement parameter, denoted as η_1.

Optionally, the measurement parameter can be the D-H parameter of the robot, including geometric parameters between multiple rods and joints.

In the embodiment shown in FIG. 2, the entire workspace of the robot can be measured when calibrating, which can realize the automatic closed-loop calibration of the robot; and it does not need an external measurement apparatus for open-loop calibration, which reduces the cost and time consumption for the robot calibration, thus effectively improving the accuracy and efficiency of the robot calibration.

Optionally, referring to FIG. 3, FIG. 3 shows a detailed flow schematic diagram of step S300 provided by the embodiment of the present disclosure, wherein the step S300 can further include steps S310-S320.

Step S310, testing a contact strength of the probe end in contact with each test point according to a sensor on the probe end.

Optionally, when the probe end is in contact with the surface of the calibration block, if the strength is too small, the surface of the calibration block cannot be contacted; and if the strength is too large, the probe end may cause damage to the surface of the calibration block, such as poking the surface of the calibration block. The non-normal contact will cause inaccuracy of the pose data, thereby adversely affecting the accuracy during calibration. Therefore, in order for the probe end to accurately touch the plurality of test points on the surface of the calibration block, the sensor can be arranged on the probe end, so as to test the contact strength of the probe end when it contacts each test point on the surface of the calibration block. The sensor can be electrically connected to a communication module in the robot, so as to feed back the plurality of contact strengths detected to the electronic device.

Exemplarily, the sensors can be multiple models of force sensors.

Step S320, acquiring a current pose data of the robot when the contact strength satisfies a strength threshold.

The robot can be a six-shaft robot or a seven-shaft robot with a plurality of joints, wherein the angle and the position of each joint corresponding to each pose are not necessarily the same. Therefore, the pose data includes joint angle data of the plurality of joints of the robot, and a corresponding strength threshold can be set and adjusted according to the model of the force sensor and the actual demand. Exemplarily, the strength threshold can be set as 0.5N. Each contact strength can be compared to the strength threshold in real time, and the pose data corresponding to the current pose of the robot is obtained when the contact strength reaches the strength threshold.

Optionally, when the robot contacts the first test point on the Z-plane of the i-th calibration block, the current joint angle data is recorded to be θ_iZ1 when the contact strength satisfies the strength threshold. Next, the robot continues to be driven to change the pose, and the pose of the probe end is transformed to contact the second test point on the Z-plane of the i-th calibration block, wherein the current joint angle data is recorded to be θ_iZ2 when the contact strength satisfies the strength threshold. The i-th group of pose data corresponding to the i-th calibration block θ_ijk can be obtained by repeating the contact and determining process, wherein (i=1˜n, k=1˜m, m is different poses of the probe end, i.e., the amount of the test points, and j=Z plane, W plane, Y plane, U plane, or V plane).

In the embodiment shown in FIG. 3, it can control the robot to normally contact with a constant force, which avoids adverse effects on the pose data due to insufficient or excessive force, thereby effectively improving the accuracy of the pose data.

Optionally, referring to FIG. 4, FIG. 4 shows a detailed flow schematic diagram of step S400 provided by the embodiment of the present disclosure, and the step S400 can further include steps S410-S420.

Step S410, determining a setting parameter of the robot.

The set kinematic parameter of the robot can be determined according to its model, type, etc., and it is taken as the setting parameter of the robot, which can be denoted as η_2.

Step S420, substituting each pose data and the setting parameter into the i-th kinematic model, so as to determine the plurality of contact coordinates in the first coordinate system when the probe end contacts the plurality of test points.

Each pose data obtained when contacting the i-th calibration block and the setting parameter can be substituted into the i-th kinematic model for calculation, so as to obtain the plurality of contact coordinates in the first coordinate system when the probe end contacts the plurality of test points. Exemplarily, the plurality of contact coordinates of the probe end in the i-th calibration block can be assembled as the i-th group of contact coordinates, denoted as (Px_ijk(θ_ijk, η_2), Py_ijk(θ_ijk, η_2), and Pz_ijk(θ_ijk, η_2)).

In the embodiment shown in FIG. 4, the contact coordinate of the probe head in contact with the calibration block when the robot is in the plurality of different poses can be determined, so as to realize the conversion of the pose of the robot to the position in the first coordinate system, thereby effectively improving the correlation between the contact coordinates and the pose data.

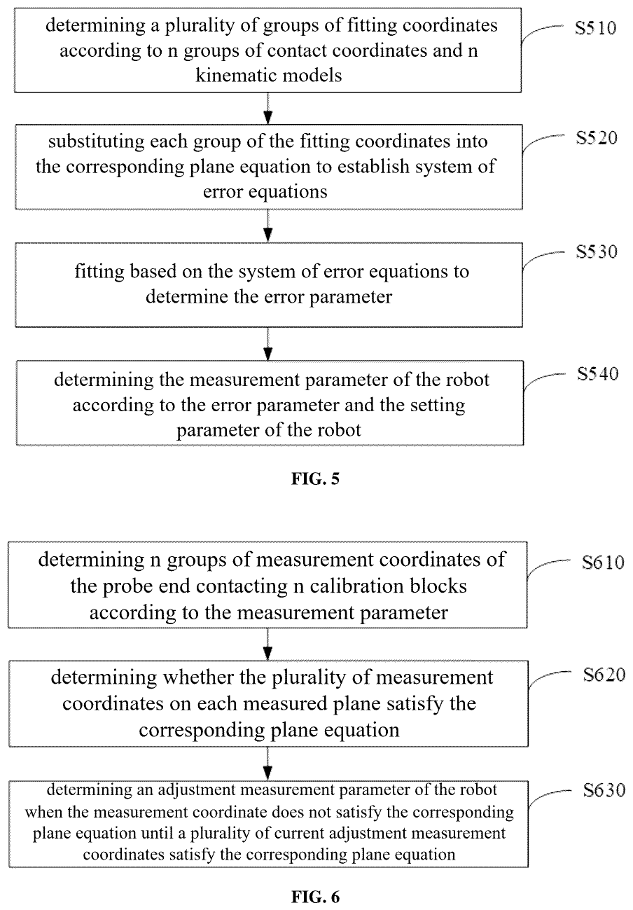

Optionally, referring to FIG. 5, FIG. 5 shows a detailed flow schematic diagram of step S500 provided by the embodiment of the present disclosure, and the step S500 can further include steps S510-S540.

Step S510, determining a plurality of groups of fitting coordinates according to n groups of contact coordinates and n kinematic models.

The plurality of groups of contact coordinates can be substituted into the Jacobi matrix of the corresponding kinematic model respectively, so as to determine the corresponding plurality of groups of fitting coordinates corresponding to the kinematic parameter set by the robot. Exemplarily, the i-th group of fitting coordinates obtained by the computation of the i-th group of contact coordinates can be denoted as (Jx(θ_ijk, η_2), Jy(θ_ijk, η_2), and Jz(θ_ijk, η_2)).

Step S520, substituting each group of the fitting coordinates into the corresponding plane equation to establish system of error equations.

Each group of fitting coordinates can be substituted into the plane equation of the corresponding measured plane of the corresponding calibration block for calculation, so as to establish the corresponding system of error equations.

Step S530, fitting based on the system of error equations to determine the error parameter.

The system of error equations can be:

$$( A\_ijJx ( θ\_ijk , η\_ 2 ) + B\_ijJy ( θ\_ijk , η\_ 2 ) + C\_ijJz ( θ\_ijk , η\_ 2 ) ) Δη = - 1 - A\_ijPx \_ijk ( θ\_ijk , η\_ 2 ) - B\_ijPy \_ijk ( θ\_ijk , η\_ 2 ) - C\_ijPz \_ijk ( θ\_ijk , η\_ 2 ) ,$$

where λη is the error parameter.

Step S540, determining the measurement parameter of the robot according to the error parameter and the setting parameter of the robot.

Since Δη=η_1-η_2, i.e., ↓_1=Δη+η_2, the actual kinematic measurement parameter of the robot can be determined through the compensation to the setting parameter by the error parameter.

In the embodiment shown in FIG. 5, it calibrates and corrects the kinematic parameter, which effectively improves the accuracy of the obtained measurement parameter.

Optionally, referring to FIG. 6, FIG. 6 shows a flow schematic diagram of another robot calibration method provided by the embodiment of the present disclosure, and the method can further include steps S610-S630.

Step S610, determining n groups of measurement coordinates of the probe end contacting n calibration blocks according to the measurement parameter.

In order to validate the acquired measurement parameters, the measurement parameters can further be substituted into a control software of the robot, which controls the robot to re-teach with the measurement parameters obtained by correction, so as to obtain the corresponding n groups of measurement coordinates in the coordinate system of the calibration blocks when the probe end contacts the n calibration blocks.

Optionally, the measurement coordinates can be acquired by using the acquisition method of the contact coordinates, which will not be described further.

Step S620, determining whether the plurality of measurement coordinates on each measured plane satisfy the corresponding plane equation.

It is to separately determine whether the plurality of measurement coordinates belonging to the same measured plane of the same calibration block satisfy the plane equation corresponding to the measured plane, which can test whether the position of the probe end is constrained to the same plane, so as to test whether the measurement parameter is accurate.

Step S630, determining an adjustment measurement parameter of the robot when the measurement coordinate does not satisfy the corresponding plane equation until a plurality of current adjustment measurement coordinates satisfy the corresponding plane equation.

When the measurement coordinates do not satisfy the corresponding plane equation, the positions of the probe end are not constrained to be in the same plane, at which time the accuracy of the measurement parameters obtained by calibration is lower. It can repeat the previous steps to re-calibrate the measurement parameters, so as to obtain the calibrated adjustment measurement parameters, and it continues to teach to obtain the corresponding adjustment measurement coordinates according to the adjustment measurement parameters. The process of calibrating and determining is repeated until the plurality of current adjustment measurement coordinates on the same measured plane satisfy the corresponding plane equation. Therefore, the accuracy of the calibration is higher, and the absolute accuracy of the robot is also higher.

In the embodiment shown in FIG. 6, the kinematic parameter of the robot can be verified after the calibration and correction, and the accuracy of calibration is improved by repeated calibration, so as to further improve the accuracy for the control of the robot.

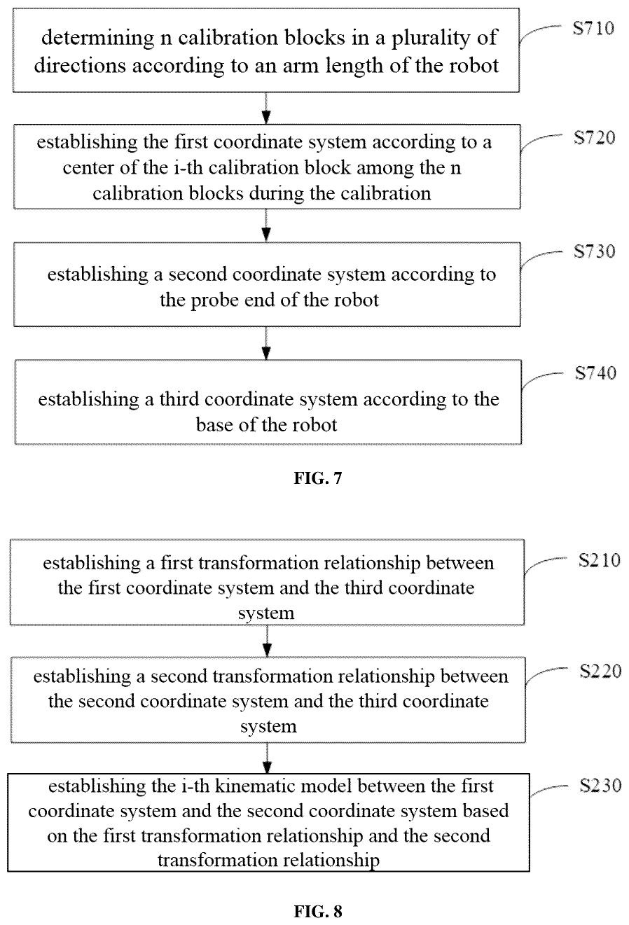

Optionally, referring to FIG. 7, FIG. 7 shows a flow schematic diagram of another robot calibration method provided by the embodiment of the present disclosure, and the method can further include steps S710-S740.

Step S710, determining n calibration blocks in a plurality of directions according to an arm length of the robot.

The n calibration blocks in different directions can be arranged on the calibration table according to the arm length of the robot, and a corresponding distance adjustment rail can also be arranged to adjust positions of the n calibration blocks.

In some optional embodiments of the present disclosure, n calibration blocks can be uniformly sized calibration blocks, wherein the error of the size is controlled in +−0.02 mm, and each calibration block can have one or more levels of plane perpendicularity, so as to improve the accuracy during testing.

Step S720, establishing the first coordinate system according to a center of the i-th calibration block among the n calibration blocks during the calibration.

The first coordinate system is established at the center of the i-th calibration block, denoted as O_XYZi.

Step S730, establishing a second coordinate system according to the probe end of the robot.

The second coordinate system O_XYZM is established centered on the probe center point of the probe end of the robot.

Step S740, establishing a third coordinate system according to the base of the robot.

The third coordinate system O_XYZR is established centered on the center point of the base of the robot.

In the embodiment shown in FIG. 7, the plurality of corresponding calibration blocks can be determined according to the arm length of the robot, so as to establish corresponding coordinate systems according to the calibration block, the probe end of the robot, and the base during the calibration respectively.

Optionally, referring to FIG. 8, FIG. 8 shows a detailed flow schematic diagram of step S200 provided by the embodiment of the present disclosure, and the step S200 can further include steps S210-S230.

Step S210, establishing a first transformation relationship between the first coordinate system and the third coordinate system.

The first transformation relationship between the first coordinate system and the third coordinate system can be established according to the positional relationship between the first coordinate system and the third coordinate system, and it is denoted as A.

Step S220, establishing a second transformation relationship between the second coordinate system and the third coordinate system.

The second transformation relationship between the second coordinate system and the third coordinate system can be established according to the positional relationship between the second coordinate system and the third coordinate system, wherein the second transformation relationship can be a homogeneous transformation matrix, which can be denoted as oT_n(θ, η_2).

Optionally, since the second coordinate system is a changing coordinate system, the second transformation relationship is also a dynamic transformation relationship.

Step S230, establishing the i-th kinematic model between the first coordinate system and the second coordinate system based on the first transformation relationship and the second transformation relationship.

The i-th kinematic model V(θ, η_2), V(θ,η_2)=A*oT_n(θ, η_2) of the first coordinate system and the second coordinate system is determined according to the first transformation relationship and the second transformation relationship.

In the embodiment shown in FIG. 8, it can determine the kinematic model between each calibration block and the probe end according to the relationships between three coordinate systems of different calibration blocks and robots, so as to realize the transformation between the pose and the position.

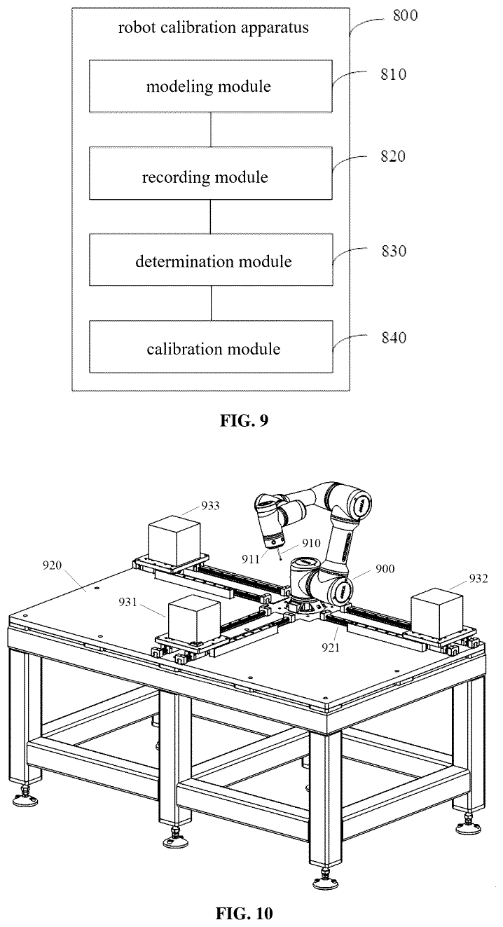

Referring to FIG. 9, FIG. 9 shows a schematic diagram of a module structure of a robot calibration apparatus provided by the embodiment of the present disclosure, and the robot calibration apparatus 800 can include:

a modeling module 810, wherein the modeling module 810 is configured to establish the i-th kinematic model between the first coordinate system of the i-th calibration block and the second coordinate system of the probe end of the robot, wherein i is a positive integer larger than or equal to 1 and smaller than or equal to n, and n is the amount of calibration blocks;

a recording module 820, wherein the recording module 820 is configured to determine a plurality of pose data of a plurality of test points on the i-th calibration block in contact with the probe end;

a determination module 830, wherein the determination module 830 is configured to determine a plurality of contact coordinates of the probe end according to the plurality of the pose data and the i-th kinematic model; and

a calibration module 840, wherein the calibration module 840 is configured to determine a measurement parameter of the robot according to n groups of contact coordinates corresponding to n calibration blocks.

In an optional embodiment, the recording module 820 can further include a strength submodule and a determination submodule, wherein
the strength submodule is used to test a contact strength of the probe end in contact with each test point according to a sensor on the probe end, and
the determination submodule is used to acquire a current pose data of the robot when the contact strength satisfies a strength threshold, wherein the pose data includes joint angle data of a plurality of joints of the robot.

In an optional implementation, the determination module 830 can further include a parameter submodule and a coordinate submodule, wherein
the parameter submodule is used to determine a setting parameter of the robot, and
the coordinate submodule is used to substitute each pose data and the setting parameter into the i-th kinematic model, so as to determine the plurality of contact coordinates in the first coordinate system when the probe end contacts the plurality of test points.

In an optional embodiment, the robot calibration apparatus 800 can further include a plane module, used to establish the corresponding plane equation according to each measured plane of the i-th calibration block, wherein the i-th calibration block includes the plurality of measured planes, and each measured plane includes the plurality of test points.

In an optional embodiment, the calibration module 840 can further include a fitting submodule, an error submodule, and a calculation submodule, wherein
the fitting submodule is used to determine a plurality of groups of fitting coordinates according to n groups of contact coordinates and n kinematic models;
the error submodule is used to substitute each group of the fitting coordinates into the corresponding plane equation to establish system of error equations, and to fit based on the system of error equations to determine the error parameter; and
the calculation submodule is used to determine the measurement parameter of the robot according to the error parameter and the setting parameter of the robot.

In an optional embodiment, the robot calibration apparatus 800 can further include a test module, which is used to determine n groups of measurement coordinates of the probe end contacting n calibration blocks according to the measurement parameter; determine whether the plurality of measurement coordinates on each measured plane satisfy the corresponding plane equation; and determine the adjustment measurement parameter of the robot when the measurement coordinate does not satisfy the corresponding plane equation until the plurality of current adjustment measurement coordinates satisfy the corresponding plane equation.

In an optional embodiment, the robot calibration apparatus 800 can further include a coordinate construction module, which is used to determine n calibration blocks in the plurality of directions according to the arm length of the robot; establish the first coordinate system according to a center of the i-th calibration block among the n calibration blocks during the calibration; establish the second coordinate system according to the probe end of the robot; and establish the third coordinate system according to the base of the robot.

In an optional implementation, the modeling module 810 can further include a transformation submodule and a construction submodule.

The transformation submodule is used to establish the first transformation relationship between the first coordinate system and the third coordinate system, and establish the second transformation relationship between the second coordinate system and the third coordinate system.

The construction submodule is used to establish the i-th kinematic model between the first coordinate system and the second coordinate system based on the first transformation relationship and the second transformation relationship.

Since the principle of the robot calibration apparatus 800 in the embodiment of the present disclosure for solving problems is similar to that of the foregoing embodiments of the robot calibration method, the embodiment of the robot calibration apparatus 800 in the present embodiment can be referred to the description of the foregoing embodiments of the robot calibration method, which will not be repeated.

Optionally, referring to FIG. 10, FIG. 10 shows an operation schematic diagram of a robot calibration method provided by the embodiment of the present disclosure. The robot 900 is arranged on the calibration table 920; the end of the robot 900 is the probe end 910; the probe end is provided with the sensor 911. The electronic device 100 can be arranged inside the robot 900 or can be a separate device. The calibration table 920 is provided with a distance adjustment rail 921, and three calibration blocks are arranged on the distance adjustment rail 921, including the first calibration block 931, the second calibration block 932, and the third calibration block 933, or other amount of calibration blocks can be provided, which will not be shown for other cases. The distance adjustment rail 921 can adjust positions and distances of the first calibration block 931, the second calibration block 932, and the third calibration block 933, so that the robot can test the entire workspace, which effectively improves the accuracy during testing.

The embodiments of the present disclosure further provide a computer-readable storage medium, and the computer-readable storage medium stores computer program instructions, wherein the computer program instructions perform the steps in any one of the robot calibration method provided by the embodiment when read and run by one processor.

In summary, the embodiments of the present disclosure provide a robot calibration method, apparatus, electronic device, and storage medium. The transformation between the pose and the position can be realized by the kinematic model, wherein the entire workspace of the robot can be measured when calibrating, and the actual kinematic parameter of the robot can be determined, which can realize the automatic closed-loop calibration of the robot; and it does not need an external measurement apparatus for open-loop calibration, which reduces the cost and time consumption for the robot calibration, thus effectively improving the accuracy and efficiency of the robot calibration.

In the embodiments provided by the present disclosure, it should be understood that the disclosed device may also be realized in other ways. The embodiments of the device described above are only illustrative, for example, the block diagrams in the drawings show the architecture, functionality, and operation that may be realized by the device according to the plurality of embodiments of the present disclosure. At this point, each block in the block schematic diagram may represent a module, program segment, or a part of code, and the module, program segment, or a part of the code includes one or more executable instructions for realizing specified logical functions. It should also be noted that in some embodiments as the replacement, the functions indicated in the boxes may also occur in a different order than those indicated in the drawings. For example, two consecutive boxes can actually be executed essentially in parallel, and they can sometimes be executed in reverse order, which depends on the functions involved. It is also noted that each block and the combination of blocks in the block diagram may be realized by a dedicated hardware-based system that executes the specified function or action, or may be realized by a combination of the dedicated hardware and computer instructions.

Additionally, the various functional modules in various embodiments of the present disclosure can be integrated together to form a separate part, individual modules can exist alone, or two or more modules that can be integrated to form a separate part.

If realized in the form of a software functional module and sold or used as an individual product, the function can be stored in a computer readable storage medium. Thus, the embodiment further provides a readable storage medium with computer program instructions stored therein. When read and run by a processor, the computer program instruction performs the steps in the method described in any one of the block data storage method. Based on this understanding, the technical solution of the present disclosure is essential, the part contributing to the related art, or the part of the technical solutions can be embodied in the form of the software product. The computer software product is stored in a storage medium, including several instructions to cause a computer device (which may be a personal computer, a server, or a network device, etc.) to perform all or part of the steps of the method described in each embodiment of the present disclosure. The foregoing storage medium includes: U disk, portable hard disk, ROM (read only-memory), RAM (random access memory), disk, disc, or other medium that can store the program code.

The foregoing are merely embodiments of the present disclosure, and are not used to limit the scope of the protection of the present disclosure. For those skilled in the art, the present disclosure may have various changes and variations, and any modifications, equivalent replacements, improvements, etc., made within the spirit and principles of the present disclosure, shall be included within the scope of protection of the present disclosure. It should be noted that similar symbols and letters denote similar items in the following drawings, so that once an item is defined in a drawing, no further definition or explanation is required in the subsequent drawings.

The above is only specific embodiments of the present disclosure, but the scope of protection of the present disclosure is not limited thereto. Any person skilled in the art familiar with the technical field can easily think of variations or substitutions within the scope of the technology disclosed in the present disclosure, shall be covered by the scope of protection of the present disclosure.

It should be noted that in the text, relational terms such as “first”, and “second”, etc., in the description of the present disclosure are only used to distinguish one entity or operation from another entity or operation, and do not necessarily require or imply the existence of any such actual relationship or order between these entities or operations. Furthermore, the terms “include”, “comprise”, or any other variant thereof are intended to cover a non-exclusive inclusion, so that a process, method, item, or device comprising a set of elements includes not only those elements, but also other elements that are not explicitly listed, or elements are inherent to this process, method, item, or device. Without further limitation, the fact that an element is defined by the phrase “including . . . ” does not exclude the existence of other identical element in the process, method, item, or device including the element.

### INDUSTRIAL APPLICABILITY

The present disclosure provides a robot calibration method, apparatus, electronic device, and storage medium, and relates to the technical field of robotic automation. The method includes: establishing an i-th kinematic model between a first coordinate system of an i-th calibration block and a second coordinate system of a probe end of the robot, wherein i is a positive integer larger than or equal to 1 and smaller than or equal to n, and n is an amount of calibration blocks; determining a plurality of pose data of a plurality of test points on the i-th calibration block in contact with the probe end; determining a plurality of contact coordinates of the probe end according to the plurality of the pose data and the i-th kinematic model; and determining a measurement parameter of the robot according to n groups of contact coordinates corresponding to n calibration blocks. The present disclosure can transform the pose data when the robot is in contact according to the transformation of kinematic models and coordinates, so as to measure the real kinematic parameters when the robot moves, which realizes the automatic closed-loop calibration of the robot, and effectively improves the accuracy and efficiency of the robot calibration.

Furthermore, it will be appreciated that the robot calibration method and the robot calibration apparatus of the present disclosure are reproducible and can be applied to various industrial applications. For example, the robot calibration method and the robot calibration apparatus of the present disclosure can be used in any apparatus where the absolute accuracy of the robot needs to be improved.

1. A robot calibration method, wherein the robot calibration method comprises:
establishing an i-th kinematic model between a first coordinate system of an i-th calibration block and a second coordinate system of a probe end of the robot, wherein i is a positive integer greater than or equal to 1 and smaller than or equal to n, and n is a quantity of calibration blocks;
determining a plurality of pose data of a plurality of test points on the i-th calibration block in contact with the probe end;
determining a plurality of contact coordinates of the probe end according to the plurality of pose data and the i-th kinematic model; and
determining a measurement parameter of the robot according to n groups of the contact coordinates corresponding to the n calibration blocks.

2. The robot calibration method according to claim 1, wherein the step of determining a plurality of pose data of a plurality of test points on the i-th calibration block in contact with the probe end comprises:
testing a contact strength of the probe end in contact with each of the test points according to a sensor on the probe end; and
acquiring a current pose data of the robot when the contact strength satisfies a strength threshold, wherein the pose data comprises joint angle data of a plurality of joints of the robot.

3. The robot calibration method according to claim 1, wherein the step of determining a plurality of contact coordinates of the probe end according to the plurality of pose data and the i-th kinematic model comprises:
determining a setting parameter of the robot; and
substituting each of the pose data and the setting parameter into the i-th kinematic model, so as to determine the plurality of contact coordinates in the first coordinate system when the probe end contacts the plurality of test points.

4. The robot calibration method according to claim 1, wherein the robot calibration method further comprises:
establishing a corresponding plane equation according to each measured plane of the i-th calibration block, wherein the i-th calibration block comprises a plurality of measured planes, and each of the measured planes comprises the plurality of test points.

5. The robot calibration method according to claim 4, wherein the step of determining a measurement parameter of the robot according to n groups of the contact coordinates corresponding to the n calibration blocks comprises:
determining a plurality of groups of fitting coordinates according to the n groups of the contact coordinates and the n kinematic models;
substituting each group of the fitting coordinates into a corresponding plane equation to establish a system of error equations;
fitting based on the system of error equations to determine an error parameter; and
determining the measurement parameter of the robot according to the error parameter and the setting parameter of the robot.

6. The robot calibration method according to claim 4, wherein the robot calibration method further comprises:
determining n groups of measurement coordinates of the probe end contacting the n calibration blocks according to the measurement parameter;
determining whether the plurality of measurement coordinates on each of the measured planes satisfy a corresponding plane equation; and
determining an adjustment measurement parameter of the robot when the measurement coordinate does not satisfy the corresponding plane equation until a plurality of current adjustment measurement coordinates satisfy the corresponding plane equation.

7. The robot calibration method according to claim 1, wherein the robot calibration method further comprises:
determining the n calibration blocks in a plurality of directions according to an arm length of the robot;
establishing the first coordinate system according to a center of the i-th calibration block among the n calibration blocks during calibration;
establishing the second coordinate system according to the probe end of the robot; and
establishing a third coordinate system according to a base of the robot.

8. The robot calibration method according to claim 7, wherein the n calibration blocks are uniformly sized calibration blocks, and each of the calibration blocks has one or more levels of plane perpendicularity.

9. The robot calibration method according to claim 7, wherein the step of establishing an i-th kinematic model between a first coordinate system of an i-th calibration block and a second coordinate system of a probe end of the robot comprises:
establishing a first transformation relationship between the first coordinate system and the third coordinate system;
establishing a second transformation relationship between the second coordinate system and the third coordinate system; and
establishing the i-th kinematic model between the first coordinate system and the second coordinate system based on the first transformation relationship and the second transformation relationship.

10. A robot calibration apparatus, wherein the robot calibration apparatus comprises:
a modeling module, wherein the modeling module is configured to establish an i-th kinematic model between a first coordinate system of an i-th calibration block and a second coordinate system of a probe end of the robot, wherein i is a positive integer greater than or equal to 1 and smaller than or equal to n, and n is a quantity of calibration blocks;
a recording module, wherein the recording module is configured to determine a plurality of pose data of a plurality of test points on the i-th calibration block in contact with the probe end;
a determination module, wherein the determination module is configured to determine a plurality of contact coordinates of the probe end according to the plurality of the pose data and the i-th kinematic model; and
a calibration module, wherein the calibration module is configured to determine a measurement parameter of the robot according to n groups of the contact coordinates corresponding to the n calibration blocks.

11. An electronic device, wherein the electronic device comprises a memory and a processor, wherein the memory stores program instructions, and the processor executes steps of the robot calibration method according to claim 1 when running the program instructions.

12. A computer readable storage medium, wherein the computer readable storage medium stores computer program instructions, and the computer program instructions execute steps of the robot calibration method according to claim 1 when run by a processor.

13. The electronic device according to claim 11, wherein the step of determining a plurality of pose data of a plurality of test points on the i-th calibration block in contact with the probe end comprises:
testing a contact strength of the probe end in contact with each of the test points according to a sensor on the probe end; and
acquiring a current pose data of the robot when the contact strength satisfies a strength threshold, wherein the pose data comprises joint angle data of a plurality of joints of the robot.

14. The electronic device according to claim 11, wherein the step of determining a plurality of contact coordinates of the probe end according to the plurality of pose data and the i-th kinematic model comprises:
determining a setting parameter of the robot; and
substituting each of the pose data and the setting parameter into the i-th kinematic model, so as to determine the plurality of contact coordinates in the first coordinate system when the probe end contacts the plurality of test points.

15. The electronic device according to claim 11, wherein the robot calibration method further comprises:
establishing a corresponding plane equation according to each measured plane of the i-th calibration block, wherein the i-th calibration block comprises a plurality of measured planes, and each of the measured planes comprises the plurality of test points.

16. The electronic device according to claim 15, wherein the step of determining a measurement parameter of the robot according to n groups of the contact coordinates corresponding to the n calibration blocks comprises:
determining a plurality of groups of fitting coordinates according to the n groups of the contact coordinates and the n kinematic models;
substituting each group of the fitting coordinates into a corresponding plane equation to establish system of error equations;
fitting based on the system of error equations to determine an error parameter; and
determining the measurement parameter of the robot according to the error parameter and the setting parameter of the robot.

17. The computer readable storage medium according to claim 12, wherein the step of determining a plurality of pose data of a plurality of test points on the i-th calibration block in contact with the probe end comprises:
testing a contact strength of the probe end in contact with each of the test points according to a sensor on the probe end; and
acquiring a current pose data of the robot when the contact strength satisfies a strength threshold, wherein the pose data comprises joint angle data of a plurality of joints of the robot.

18. The computer readable storage medium according to claim 12, wherein the step of determining a plurality of contact coordinates of the probe end according to the plurality of pose data and the i-th kinematic model comprises:
determining a setting parameter of the robot; and
substituting each of the pose data and the setting parameter into the i-th kinematic model, so as to determine the plurality of contact coordinates in the first coordinate system when the probe end contacts the plurality of test points.

19. The computer readable storage medium according to claim 12, wherein the robot calibration method further comprises:
establishing a corresponding plane equation according to each measured plane of the i-th calibration block, wherein the i-th calibration block comprises a plurality of measured planes, and each of the measured planes comprises the plurality of test points.

20. The computer readable storage medium according to claim 19, wherein the step of determining a measurement parameter of the robot according to n groups of the contact coordinates corresponding to the n calibration blocks comprises:
determining a plurality of groups of fitting coordinates according to the n groups of the contact coordinates and the n kinematic models;
substituting each group of the fitting coordinates into a corresponding plane equation to establish system of error equations;
fitting based on the system of error equations to determine an error parameter; and
determining the measurement parameter of the robot according to the error parameter and the setting parameter of the robot.
